(19) United States
(12) Patent Application Publication
(10) Pub. No.: US 2019/0163529 A1
(43) Pub. Date: May 30, 2019

(54) OBJECT ALLOCATION METHOD AND APPARATUS

(71) Applicant: Alibaba Group Holding Limited, Grand Cayman (KY)

(72) Inventors: Guiju Gao, Zhejiang (CN); Hong Zhu, Zhejiang (CN); Feng Luo, Zhejiang (CN); Huiquan Huang, Zhejiang (CN)

(73) Assignee: Alibaba Group Holding Limited, Grand Cayman (KY)

(21) Appl. No.: 16/312,148

(22) PCT Filed: Jun. 9, 2017
(86) PCT No.: PCT/CN2017/087685

§ 371 Date: Dec. 20, 2018

(30) Foreign Application Priority Data
Jun. 21, 2016 (CN) 201610453595.5

(51) Int. Cl. G06F 9/50; H04L 29/06; H04L 12/58; G06F 16/909; G06F 16/9035

(52) U.S. Cl. CPC G06F 9/5005; H04L 63/107; G06F 16/9035; G06F 16/909; H04L 51/20

(57) ABSTRACT

The present disclosure provides an object allocation method and apparatus. The method may include: based on an object allocation request from an initiating party, generating an object allocation set; wherein, the object allocation set contains a specified number of objects extracted from among an object set corresponding to the initiating party; determining an allocation constraint condition associated with the object allocation set, the allocation constraint condition including a geographical location condition; and allocating the object allocation set to a target party, wherein the target party satisfies the allocation constraint condition. Through technical solutions of the present disclosure, allocation related to geographical location may be realized, helping to optimize object allocation operations.

### CROSS REFERENCE TO RELATED PATENT APPLICATIONS

This application claims priority to Chinese Patent Application No. 201610453595.5, filed on Jun. 21, 2016 and entitled “OBJECT ALLOCATION METHOD AND APPARATUS”, which is incorporated herein by reference in its entirety.

### TECHNICAL FIELD

The present disclosure relates to the technical field of object allocation, and particularly to an object allocation method and apparatus.

### BACKGROUND

The exchange behaviors of data objects are already widely utilized in networking technology. For example, for data objects in the form of network resources, each node of a network may have its needed network resources allocated thereto, to accommodate processing requirements of exchanges by that node in the network.

However, in related technology, network resource allocation operations are only constrained by identity information of a target network node and such dimensions; other unrelated network nodes may easily stand in, resulting in loss of network resources, while also posing high security risks.

### SUMMARY

In view of the foregoing, the present disclosure provides an object allocation method and apparatus, which may realize object allocation related to geographical location, helping to optimize object allocation operations.

To realize the above-mentioned objectives, the present disclosure provides the following technical solutions:

According to a first aspect of the present disclosure, an object allocation method is set forth, including:

Based on an object allocation request from an initiating party, generating an object allocation set; wherein, the object allocation set contains a specified number of objects extracted from among an object set corresponding to the initiating party;

Determining an allocation constraint condition associated with the object allocation set, the allocation constraint condition including a geographical location condition;

Allocating the object allocation set to a target party, wherein the target party satisfies the allocation constraint condition.

According to a second aspect of the present disclosure, an object allocation method is set forth, including:

Based on an object query request initiated by an initiating party, obtaining a real-time geographical location of the initiating party;

Returning a queried object allocation set to the initiating party, wherein the real-time geographical location satisfies a geographical location condition corresponding to the object allocation set.

According to a third aspect of the present disclosure, an object allocation apparatus is set forth, including:

A generating unit configured to, based on an object allocation request from an initiating party, generate an object allocation set; wherein, the object allocation set contains a specified number of objects extracted from among an object set corresponding to the initiating party;

A determining unit configured to determine an allocation constraint condition associated with the object allocation set, the allocation constraint condition including a geographical location condition;

An allocating unit configured to allocate the object allocation set to a target party, wherein the target party satisfies the allocation constraint condition.

According to a fourth aspect of the present disclosure, an object allocation apparatus is set forth, including:

An obtaining unit configured to, based on an object query request initiated by an initiating party, obtain a real-time geographical location of the initiating party;

A returning unit configured to return a queried object allocation set to the initiating party, wherein the real-time geographical location satisfies a geographical location condition corresponding to the object allocation set.

According to a fifth aspect of the present disclosure, a red packet tendering method in instant messaging groups is set forth, including:

In a conversation window of an instant messaging group, showing a red packet tendering gateway indicator;

Based on receiving a user trigger command directed at the red packet tendering gateway indicator, showing a red packet configuration page; wherein, the user trigger command is issued by a first group member of the instant messaging group;

Based on a user configuration command received by the red packet configuration page, generating red packet configuration information; wherein, the red packet configuration information includes a first geographical location determined by the first group member;

Initiating to the server a red packet tendering request containing the red packet information, causing the server to create a red packet associated with the first geographical location, and the server to send an instant messaging message regarding the red packet to at least one second group member(s) of the instant messaging group, further causing the at least one second group member(s) to, through a trigger towards the instant messaging group, and in the case when second geographical location(s) of the at least one second group member(s) satisfy a preset relationship with the first geographical location, receive at least part of the red packet.

According to a sixth aspect of the present disclosure, an instant messaging group red packet receiving method is set forth, including:

In a conversation window of an instant messaging group, showing an instant messaging message from a first group member, the instant message corresponding to a red packet tendered by the first group member;

When the red packet is associated with a first geographical location of the first group member, based on receiving a red packet receiving command from a second group member directed at the instant messaging message, obtaining a second geographical location of the second group member;

In the case where the second geographical location satisfies a preset relationship with the first geographical location, showing on a prompt page that at least part of the red packet is successfully received by the second group member.

According to a seventh aspect of the present disclosure, an instant messaging group red packet tendering apparatus is set forth, including:

An indicator displaying unit configured to, in a conversation window of an instant messaging group, show a red packet tendering gateway indicator;

A page displaying unit configured to, based on receiving a user trigger command directed at the red packet tendering gateway indicator, show a red packet configuration page; wherein, the user trigger command is issued by a first group member of the instant messaging group;

An information generating unit configured to, based on a user configuration command received by the red packet configuration page, generate red packet configuration information; wherein, the red packet configuration information includes a first geographical location determined by the first group member;

A red packet tendering unit configured to initiate to the server a red packet tendering request containing the red packet information, causing the server to create a red packet associated with the first geographical location, and the server to send an instant messaging message regarding the red packet to at least one second group member(s) of the instant messaging group, further causing the at least one second group member(s) to, through a trigger towards the instant messaging group, and in the case when second geographical location(s) of the at least one second group member(s) satisfy a preset relationship with the first geographical location, receive at least part of the red packet.

According to an eighth aspect of the present disclosure, an instant messaging group red packet receiving apparatus is set forth, including:

A message displaying unit configured to, in a conversation window of an instant messaging group, show an instant messaging message from a first group member, the instant message corresponding to a red packet tendered by the first group member;

A location obtaining unit configured to, when the red packet is associated with a first geographical location of the first group member, based on receiving a red packet receiving command from a second group member directed at the instant messaging message, obtain a second geographical location of the second group member;

A receiving displaying unit configured to, in the case where the second geographical location satisfies a preset relationship with the first geographical location, show on a prompt page that at least part of the red packet is successfully received by the second group member.

By the above technical solutions it may be seen that the present disclosure, through setting an allocation constraint condition, particularly a geographical location condition, establishes association between allocation operations and geographical locations of objects, which may impart regional characteristics to allocation operations of objects, limiting target parties to within a geographical location defined by an initiating party, which may prevent operating parties in other geographical locations standing in for target parties, helping to improve security of object allocation.

### BRIEF DESCRIPTION OF THE DRAWINGS

FIG. 1 is a flowchart of an object allocation method provided by an exemplary embodiment of the present disclosure;

FIG. 2A is a flowchart of an instant messaging group red packet tendering method provided by an exemplary embodiment of the present disclosure;

FIG. 2B is a flowchart of an instant messaging group red packet receiving method provided by an exemplary embodiment of the present disclosure;

FIG. 2C is a flowchart of another object allocation method provided by an exemplary embodiment of the present disclosure;

FIGS. 3-10 are object allocation interface diagrams provided by an exemplary embodiment of the present disclosure;

FIG. 11 is a flowchart of still another object allocation method provided by an exemplary embodiment of the present disclosure;

FIGS. 12-13 are another set of object allocation interface diagrams provided by an exemplary embodiment of the present disclosure;

FIG. 14 is a flowchart of still another object allocation method provided by an exemplary embodiment of the present disclosure;

FIG. 15 is a flowchart of still another object allocation method provided by an exemplary embodiment of the present disclosure;

FIGS. 16-20 are still another set of object allocation interface diagrams provided by an exemplary embodiment of the present disclosure;

FIG. 21 is a schematic diagram of an electronic device provided by an exemplary application of the present disclosure;

FIG. 22 is a block diagram of an object allocation apparatus provided by an exemplary embodiment of the present disclosure;

FIG. 23 is a schematic diagram of another electronic device provided by an exemplary embodiment of the present disclosure;

FIG. 24 is a block diagram of another object allocation apparatus provided by an exemplary embodiment of the present disclosure;

FIG. 25 is a schematic diagram of still another electronic device provided by an exemplary embodiment of the present disclosure;

FIG. 26 is a block diagram of an instant messaging group red packet tendering apparatus provided by an exemplary embodiment of the present disclosure;

FIG. 27 is a schematic view of still another electronic device provided by an exemplary embodiment of the present disclosure;

FIG. 28 is a block diagram of an instant messaging group red packet receiving apparatus provided by an exemplary embodiment of the present disclosure.

### DETAILED DESCRIPTION

The present disclosure, through imparting geographical location characteristics upon an object allocation procedure, may optimize object allocation solutions in related technology. To further describe the present disclosure, example embodiments are provided below:

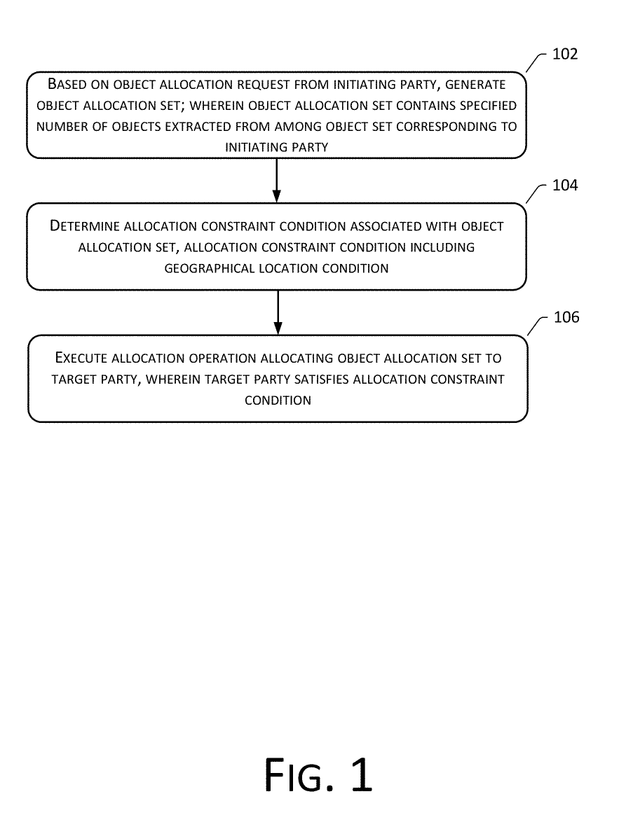

FIG. 1 is a flowchart of an object allocation method provided by an exemplary embodiment of the present disclosure. As illustrated by FIG. 1, the method, as applied to a server, may include the following steps:

Step 102, based on an object allocation request from an initiating party, generating an object allocation set; wherein, the object allocation set contains a specified number of objects extracted from among an object set corresponding to the initiating party;

According to the present example embodiment, an object may include any exchangeable element, enabling the objects to be allocated between different users, that is, for an object to be exchanged from one user to another user. For example, an object may be a virtual item, such as currency, a coupon, a voucher, and the like, such that an object set is equivalent to an account or an electronic wallet and the like of a user; after a specified number of objects is extracted as an object allocation set, the object allocation set may be understood as a user-generated “red packet” and the like, to be allocated to a target user.

According to the present example embodiment, an initiating party, as well as a below-mentioned target party and the like, are respectively users serving as an “initiating party” and a “target party.” Users, through utilizing corresponding electronic devices, may implement data exchange mutually or between servers. Each user may engage in exchange through a set electronic device, in which case through recording, for example, MAC addresses, device ID and the like of these electronic devices, different electronic devices, and therefore an initiating party, a target party and such different users, may be recognized. Each user may also engage in exchange through multiple electronic devices, in which case through recording a singular corresponding account information registered by a user in advance, as well as the electronic device where the account information is currently logged in, a corresponding user may be recognized. Of course, different users may be recognized through other fashions in relevant technology, and the present disclosure shall not be limiting thereto.

Step 104, determining an allocation constraint condition associated with the object allocation set, the allocation constraint condition including a geographical location condition.

According to the present example embodiment, a server may obtain geographical location of an initiating party, where the geographical location may be uploaded to the server by an electronic device of the initiating party, or server-initiated location recognition may be performed upon the initiating party (for example, when the electronic device is a mobile phone or such mobile communication devices, its geographical location may be derived from a base station position; alternatively, the server may derive a Wi-Fi hotspot that the electronic device is currently connected to, designating a deployment location of the Wi-Fi hotspot as the geographical location of the initiating party; alternatively, other feasible fashions) and the location obtained. Accordingly, geographical location conditions may include: being within a preset distance range from the geographical position, such as being within a 200-meter range from the initiating party. According to this example embodiment, through an allocation constraint condition for the object allocation set, a regional characteristic is conferred to the object allocation set, facilitating the combination of virtual object allocation operations executed online with offline entities, so as to unite the convenience of online allocation operations and the actuality of offline settings.

Herein, the geographical location of the initiating party may include any of the following: a geographical location of the initiating party while initiating the object allocation request; a geographical location of the initiating party while the target party initiates an object obtaining request, wherein the object obtaining request is utilized to trigger the allocation operation; and an arbitrary geographical location specified by the initiating party.

According to the present example embodiment, the allocation constraint condition may further include other conditions, such as a user identity condition. For example, when the server further determines an organization to which the initiating party belongs, the user identity condition may include: belonging to a same organization as the initiating party. According to this example embodiment, through adding the user identity condition, the scope of target parties may be further limited, and allocation operations of objects may be made more targeted. Particularly with regard to certain specific scenarios, an especially positive experience may be provided to the user, such as, for example, by implementing: when sending red packets near a company, only personnel having already arrived at the company may receive the red packets. Personnel not yet on duty (in accordance with the user identity condition, but at a distant geographical location and thus not in accordance with the geographical location condition), personnel of other companies in a same office building (in accordance with the geographical location condition, but not being in the same organization and thus not in accordance with the user identity condition) and the like are unable to receive red packets.

Step 106, executing an allocation operation allocating the object allocation set to a target party, wherein the target party satisfies the allocation constraint condition.

According to the present example embodiment, the object allocation request may be initiated by the initiating party through a conversation window of an instant messaging application. Herein, the target party is an associated communicating party of the conversation window. The instant messaging application may be any application capable of implementing instant messaging, and the instant messaging application may be an enterprise instant messaging (EIM) application, such DingTalk.

According to the present example embodiment, the server may directly allocate the object allocation set to a target party in accordance with the allocation constraint condition. Alternatively, the server may, after receiving an object obtaining request initiated by any user directed at the object allocation set, and in the case of determining that the any user is in accordance with the allocation constraint condition, designate the any user as a target user, and execute the allocation operation upon the object allocation set.

It may be seen from the above-mentioned technical solution that the present disclosure, through setting an allocation constraint condition, particularly a geographical location condition, establishes association between allocation operations and geographical locations of objects, which in one regard may impart regional characteristics to allocation operations of objects, and in another regard may, through the actuality of geographical locations, establish online to offline user relationships between an allocation source party and a target party of an object allocation set, helping to optimize object allocation operations and experiences of each participant. At the same time, through limiting target parties to within a geographical location defined by an initiating party, operating parties in other geographical locations may be prevented from standing in for target parties, helping to improve security of object allocation.

Technical solutions of the present disclosure may be applied to any object allocation setting; to facilitate understanding, below, with a “red packet” scenario as an example, from the two aspects of tendering a red packet and receiving a red packet, an object allocation scheme based on the present disclosure will be described.

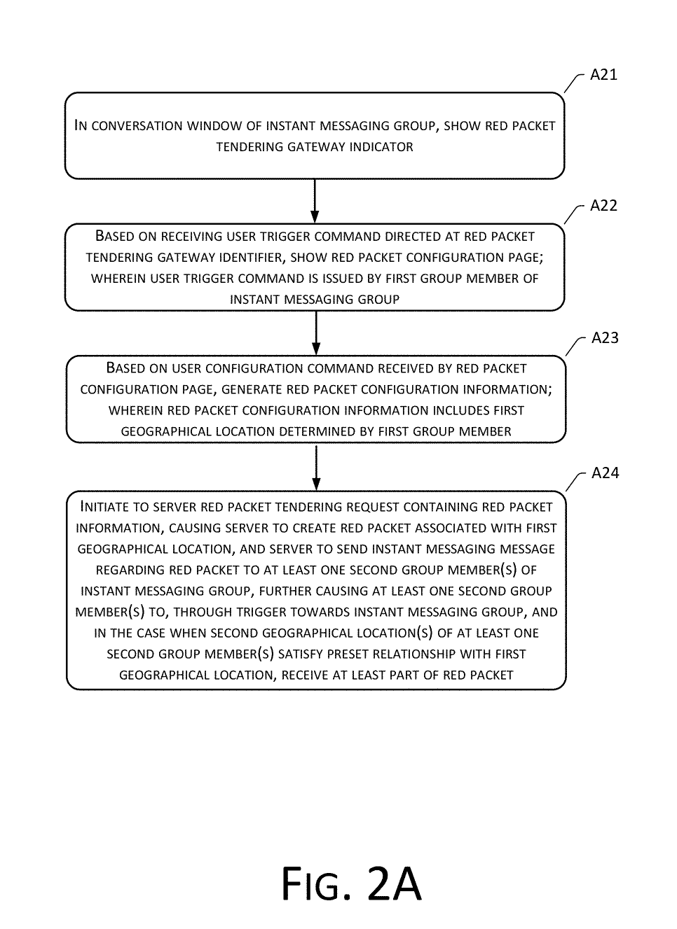

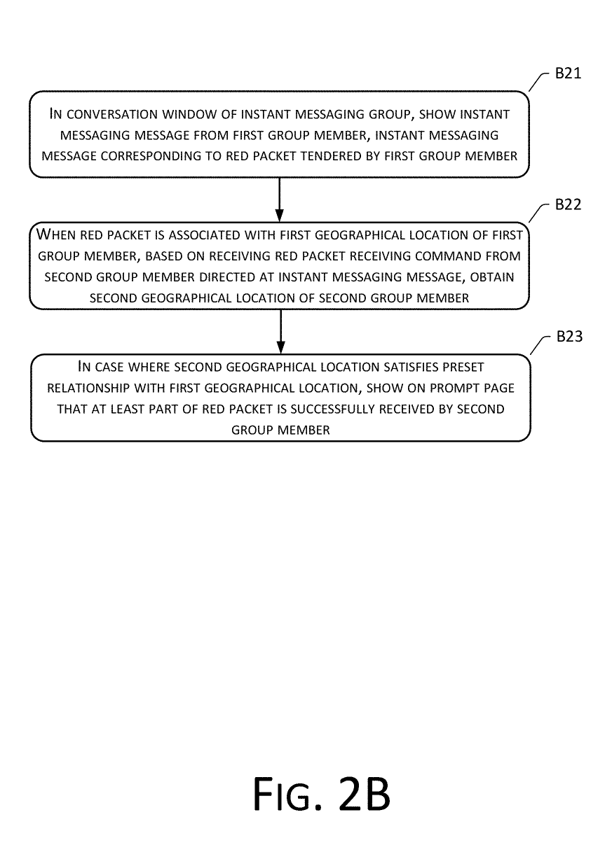

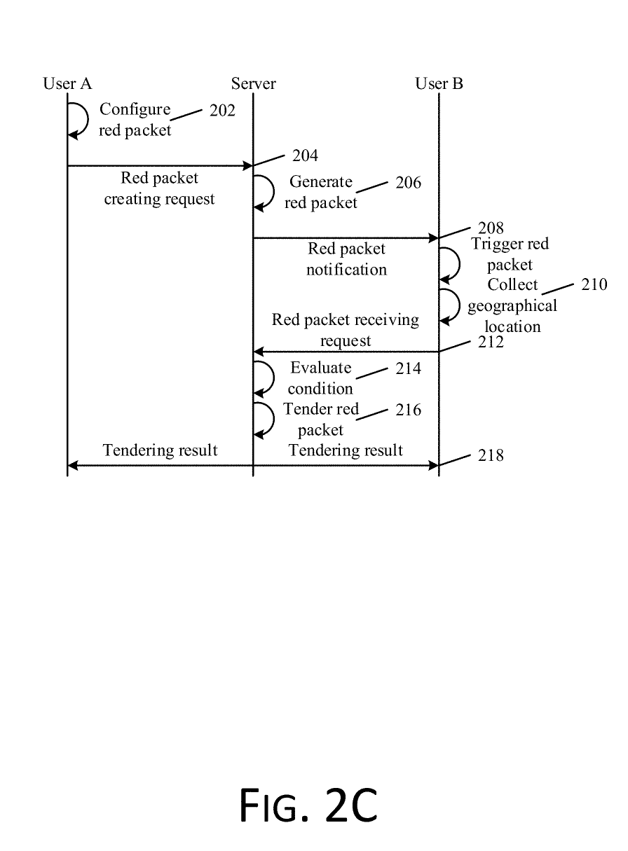

FIG. 2A is a flowchart of an instant messaging group red packet tendering method provided by an exemplary embodiment of the present disclosure. As illustrated by FIG. 2A, the method is applied to an electronic device of a first group member designated as an initiating party, and may include the following steps:

Step A21, in a conversation window of an instant messaging group, showing a red packet tendering gateway indicator.

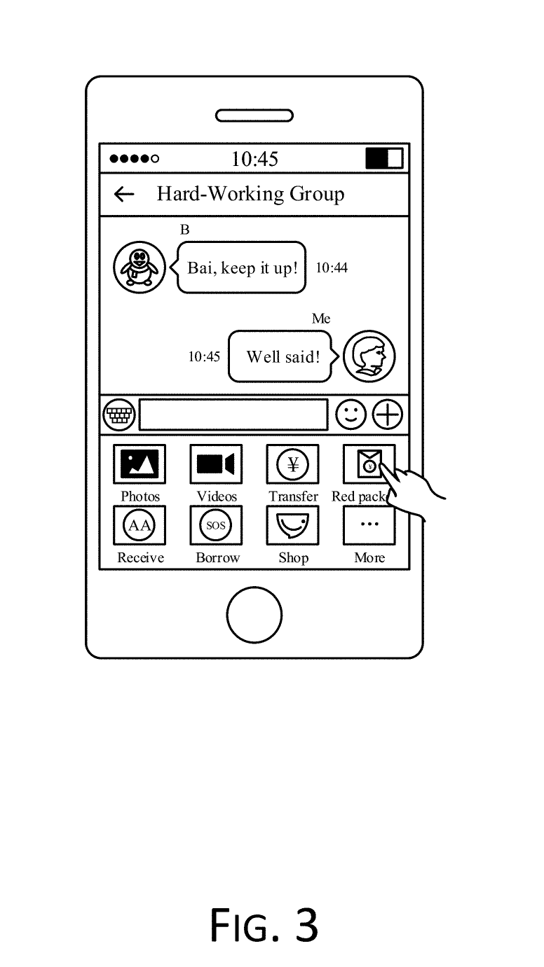

According to the present example embodiment, the particular form of the red packet tendering gateway indicator shall not be limited. For example, supposing that FIG. 3 illustrates a conversation window of an instant messaging group “Hard-Working Group.” Upon detecting that a first group member (the conversation window illustrated in FIG. 3 being displayed on a display screen of an electronic device of the first group member) has triggered the “s” at the bottom right of the conversation window, the function menu illustrated at the bottom half of FIG. 3 may be shown, the function menu including function icons and text descriptions of “Photos,” “Videos,” “Transfers,” “Red packets,” and such operational functions. The red packet tendering gateway indicator may be identified by the “Red packet” function icon and text.

Step A22, based on receiving a user trigger command directed at the red packet tendering gateway identifier, showing a red packet configuration page; wherein, the user trigger command is issued by a first group member of the instant messaging group.

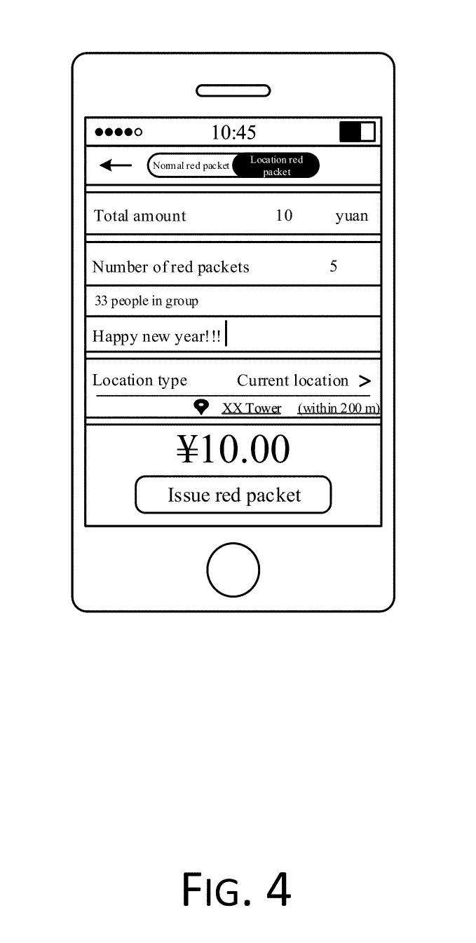

According to the present example embodiment, upon detecting a clicking trigger operation of the first group member towards the red packet tendering gateway indicator as illustrated by FIG. 3, a user trigger command may be considered received, and a transition is made to the red packet configuration page as illustrated by FIG. 4 for engaging in configuration operations of a red packet.

Step A23, based on a user configuration command received by the red packet configuration page, generating red packet configuration information; wherein, the red packet configuration information includes a first geographical location determined by the first group member.

According to the present example embodiment, in one regard, on the red packet configuration page illustrated by FIG. 4, based on user configuration commands, “Total amount,” “Number of red packets,” “Location type” and the like may, respectively, be selected for configuration, and “Happy new year!!!” and such descriptive information may be added to the red packet.

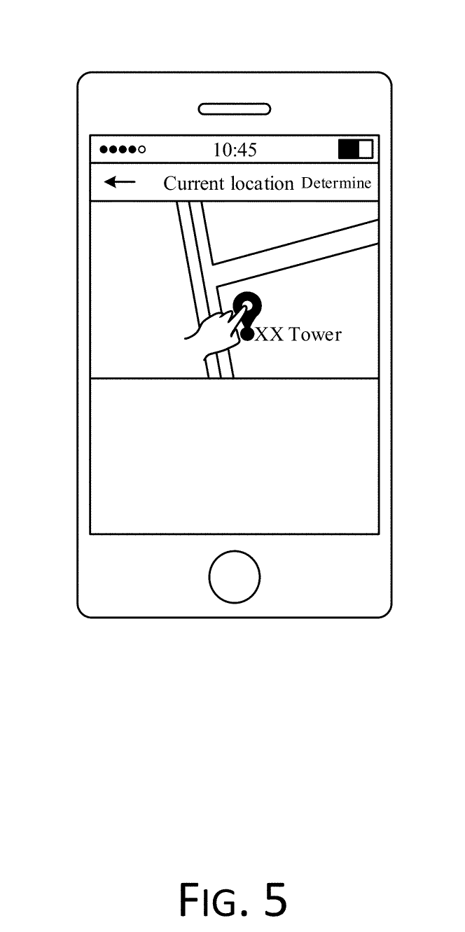

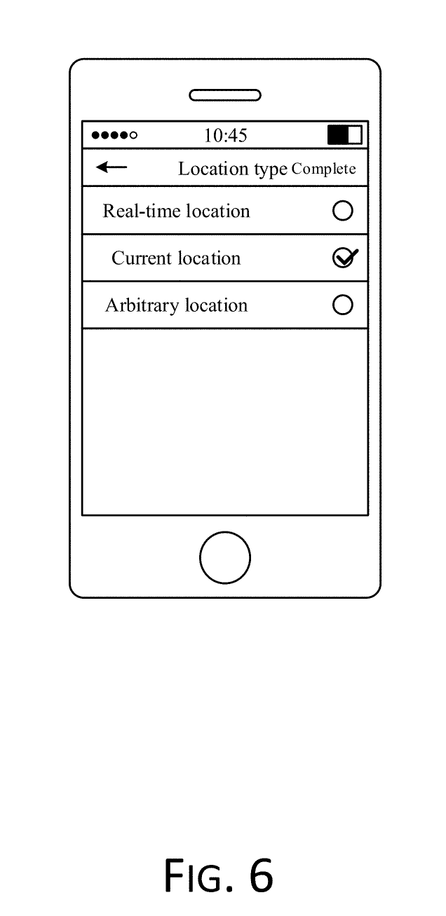

In another regard, when the red packet type is a “location red packet” as illustrated by FIG. 4, that is, a type of red packet based on technical solutions of the present disclosure, now the first group member may determine an associated first geographical location for the red packet. Based on difference between “location types” of red packets, the first geographical location will correspondingly be different: in a first case, as illustrated by FIG. 4, when the configured “location type” of the red packet is “current location,” the first geographical location may be the geographical location where the first group member performed configuration operations upon the red packet (such as “XX Tower”), and the first group member may also, through the configuration adjustment page illustrated by FIG. 5, make fine adjustments to the first geographical location. In a second case, through the type adjustment page illustrated by FIG. 6, the first group member may switch “place type” to “real-time location,” causing the first geographical location to vary with movements of the first group member, rather than be a fixed location. In a third case, through the type adjustment page illustrated by FIG. 6, the first group member may switch “place type” to “arbitrary location,” causing the first geographical location to be an arbitrary location specified by the first group member, similar to “current location,” but now the first geographical location will not further vary after being determined.

Step A24, initiating to the server a red packet tendering request containing the red packet information, causing the server to create a red packet associated with the first geographical location, and the server to send an instant messaging message regarding the red packet to at least one second group member(s) of the instant messaging group, further causing the at least one second group member(s) to, through a trigger towards the instant messaging group, and in the case when second geographical location(s) of the at least one second group member(s) satisfy a preset relationship with the first geographical location, receive at least part of the red packet.

Correspondingly, FIG. 2B is a flowchart of an instant messaging group red packet receiving method provided by an exemplary embodiment of the present disclosure. As illustrated by FIG. 2B, the method is applied to an electronic device of a second group member designated as a target party, and may include the following steps:

Step B21, in a conversation window of an instant messaging group, showing an instant messaging message from a first group member, the instant messaging message corresponding to a red packet tendered by the first group member.

Step B22, when the red packet is associated with a first geographical location of the first group member, based on receiving a red packet receiving command from a second group member directed at the instant messaging message, obtaining a second geographical location of the second group member.

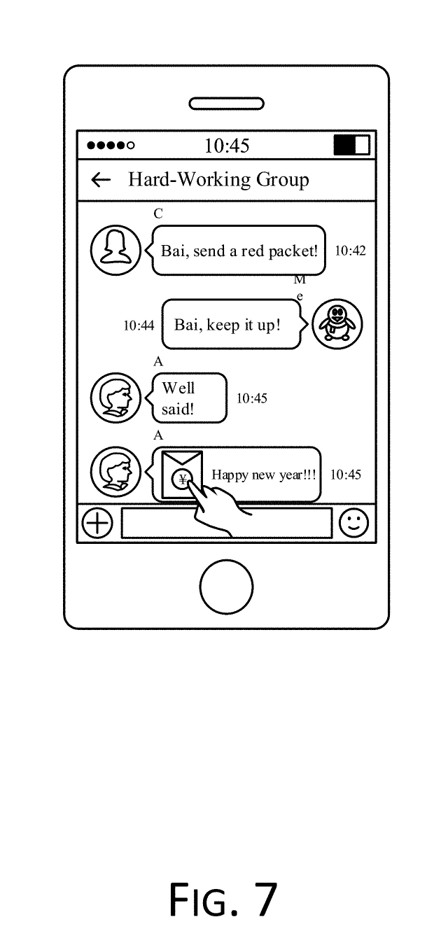

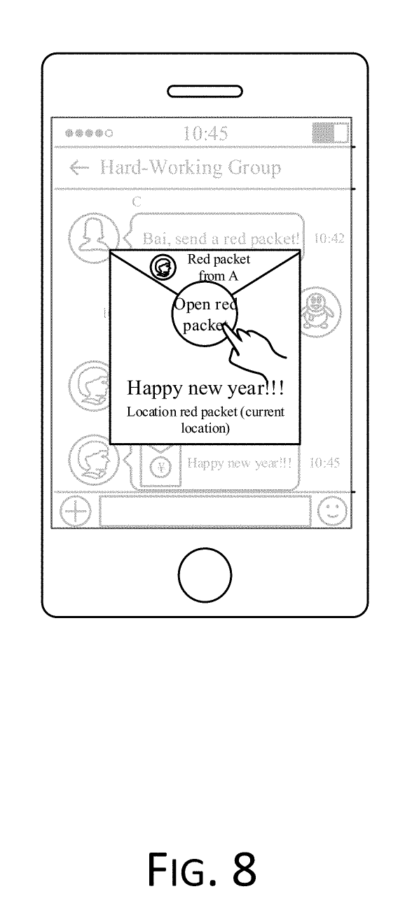

According to the present example embodiment, as illustrated by FIG. 7, a red packet issued by the first group member may serve as content of an instant messaging message, shown in a message box of the conversation window, and upon detecting a trigger operation by the second group member towards the message box, this may be evaluated as detecting a red packet receiving command. Of course, in some cases, based on a trigger command by the second group member towards the message box illustrated by FIG. 7, a red packet receiving page illustrated by FIG. 8 may be shown, and upon detecting that the second group member further clicks on an “Open red packet” text and icon on the red packet receiving page, this may be evaluated as detecting a red packet receiving command.

According to the present example embodiment, the second group member, through a personal electronic device, views the above-mentioned instant messaging message. The electronic device may contain a positioning chip therein, and thereby upon detecting the above-mentioned red packet receiving command, may obtain a personal second geographical location (which may be equivalent to a second geographical location of the second group member), utilized to evaluate whether the second geographical location satisfies a preset relationship with the first geographical location.

Step B23, in the case where the second geographical location satisfies a preset relationship with the first geographical location, showing on a prompt page that at least part of the red packet is successfully received by the second group member.

According to the present example embodiment, a preset relationship between the first geographical location and the second geographical location may include: the second geographical location being within a preset distance range from the first geographical position. Of course, other preset relationships capable of reflecting geographical location characteristics may be employed, and the present disclosure shall not be limiting thereto.

Herein, whether the second geographical location satisfies a preset relationship with the first geographical location may be evaluated by the server, which requires the first group member and the second group member each using their electronic devices to respectively upload the first geographical location and the second geographical location to the server (of course, the server may also through triangulation, and such other fashions, respectively obtain the first geographical location and the second geographical location, without the need for proactive uploading via the electronic devices). Alternatively, the first geographical location is sent to the electronic device of the second group member, and the electronic device performs evaluation thereof; alternatively, the second geographical location is sent to the electronic device of the first group member, and the electronic device performs evaluation thereof; alternatively, another trusted third party performs evaluation thereof, and the present disclosure shall not be limiting thereto.

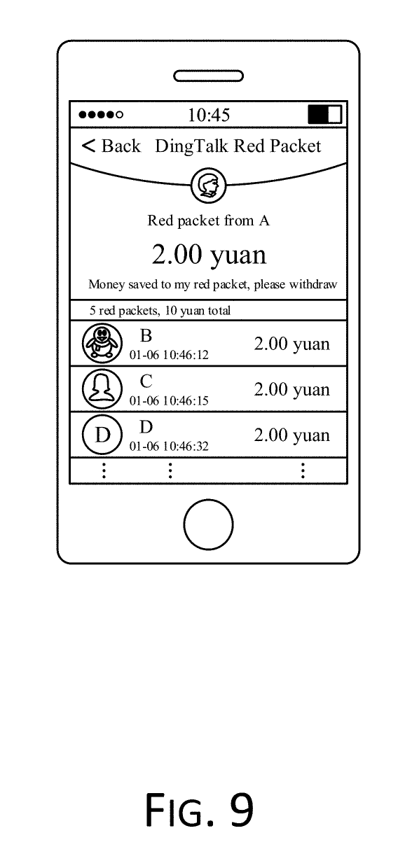

According to the present example embodiment, when the preset relationship is satisfied between the first geographical location and the second geographical location, the server may allocate at least part of the objects of the red packets (for example, currency) to the second group member, such as by transferring currency to an account of the second group member. The electronic device used by the second group member may, through a prompt page as illustrated by FIG. 9, determine that the second group member has successfully received at least part of the red packet, and the second group member may view the receiving information of the red packet on the prompt page, such as user B, user C, user D and the like of FIG. 9 having respectively received part of the currency in the red packet.

Furthermore, below, the exchange procedure between the initiating party, the target party and the server is taken in conjunction to describe an object allocation scheme according to the present disclosure. Herein, FIG. 2C is a flowchart of another object allocation method provided by an exemplary embodiment of the present disclosure. As illustrated by FIG. 2C, the method may include the following steps:

Step 202, user A configuring a red packet.

According to the present example embodiment, to facilitate understanding, suppose that “objects” are currency and an “object allocation set” is a red packet, and with the scenario of “sending red packets” as an example, technical solutions according to the present disclosure will be described by example.

According to the present example embodiment, with an application page of “DingTalk” as an example, the tendering of red packets by an initiating party user A in an enterprise instant messaging setting is described in detail.

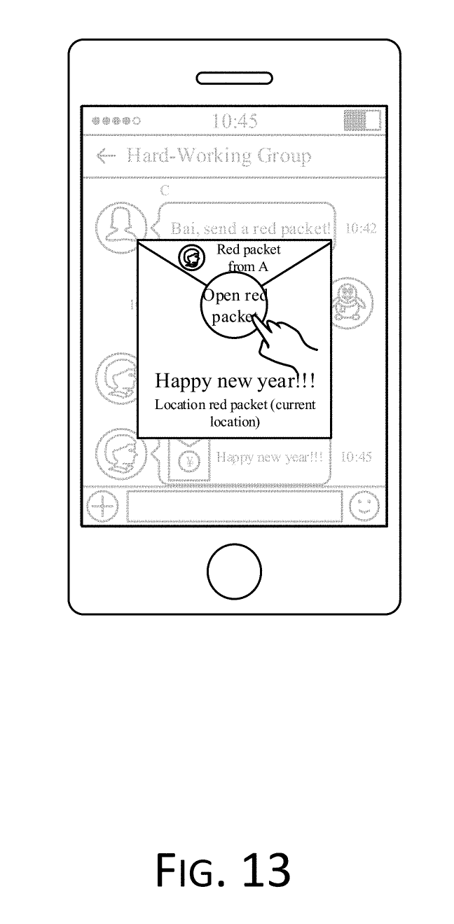

Suppose that user A, user B the like are member users in organization “Hard-Working Group,” and FIG. 13 is a conversation window on an electronic device used by user A corresponding to “Hard-Working Group.” Then, upon detecting that user A has triggered the “s” at the bottom right of the conversation window, the function menu illustrated at the bottom half of FIG. 13 may be shown, the function menu including function icons and text descriptions of “Photos,” “Videos,” “Transfer,” “Red packets,” and such operational functions. Upon detecting that a trigger operation by user A towards the “Red packets” function icon, a transition may be made to the red packet configuration page as illustrated by FIG. 4 for engaging in configuration operations of a red packet.

As illustrated by FIG. 4, a type of red packet based on technical solutions of the present disclosure may be a “location red packet,” and a type of red packet based on related technology may be a “normal red packet,” and the like. Based on switching operations by user A, switching and configuration may be performed among different types of red packets. On the red packet configuration page illustrated by FIG. 4, based on detecting configuration commands by user A, “Total amount,” “Number of red packets,” “Location type” and the like may, respectively, be selected for configuration, and “Happy new year!!!” and such descriptive information may be added to the red packet.

According to the example embodiment illustrated by FIG. 4, when the configured “location type” of the red packet is “current location,” that is the geographical location where user A performed configuration operations upon the red packet, such as “XX Tower.” Upon detecting a trigger by user A towards “XX Tower” as illustrated by FIG. 4, a transition may be made to the configuration adjustment page illustrated by FIG. 5, where, based on dragging operations by user A towards the location marker on the map illustrated by FIG. 5, fine adjustments may be made to the “current location.” Of course, red packets according to the present disclosure may have other “place types”; for example, upon detecting a trigger by user A towards “Current location” as illustrated by FIG. 4, a transition may be made to the type adjustment page illustrated by FIG. 6, where, based on selection operations by user A towards the various types illustrated by FIG. 6, switching is performed between different location types, such as “current location” being switched to “real-time location” or “arbitrary location” and the like.

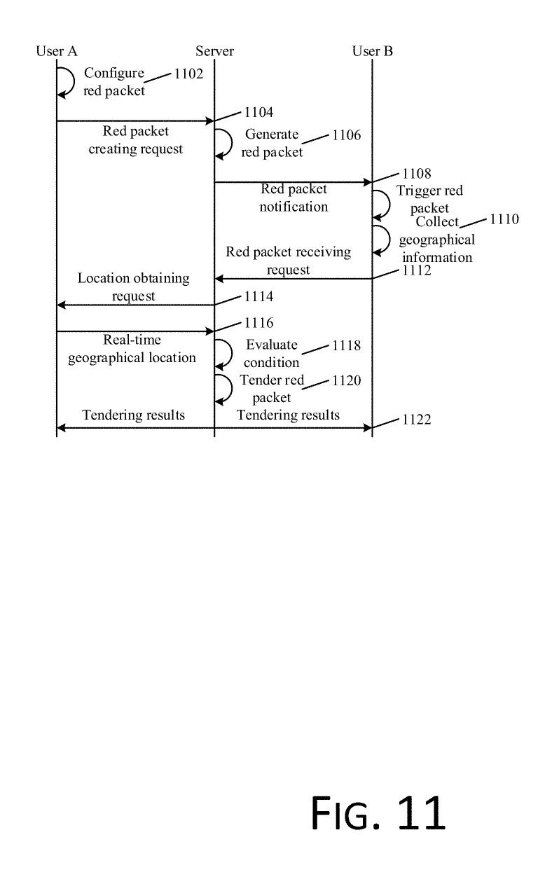

Herein, “real-time location” refers to a real-time geographical location of initiating party user A, and “arbitrary location” refers to a geographical location arbitrarily specified by user A. Herein, processing flows under “arbitrary location” and “current location” require user A to configure a fixed geographical location for the red packet, which may refer to the processing flow illustrated by FIG. 2C, whereas a real-time geographical location under “real-time location” may vary, and will be subsequently described in detail in conjunction with FIG. 11.

According to the present example embodiment, through the type configuration page illustrated by FIG. 5, user A may configure the geographical location corresponding to a current red packet. Corresponding to the geographical location, an employed geographical location condition may be a default condition, such “(within 200 m)” as illustrated by FIG. 4, indicating that the geographical location condition is “within a 200-meter range from the geographical location corresponding to the red packet”; of course, based on a trigger operation by user A towards “(within 200 m),” the range of “200 m” may be adjusted, such as adjustment to “within 100 m,” “within 1 km,” and the like.

Step 204, the server receiving a red packet creating request initiated by user A.

According to the present example embodiment, upon detecting a trigger operation by user A towards the “Red packet” button on the red packet configuration page illustrated by FIG. 4, the corresponding electronic device may initiate a red packet creating request towards the server, the red packet creating request containing the various information of FIG. 4 already configured by user A.

Step 206, the server generating a red packet.

According to the present example embodiment, while the server generates a red packet, if the red packet creating request is based on the red packet configuration page illustrated by FIG. 4, then, aside from extracting a specified amount (“10 yuan” as illustrated by FIG. 4) of currency from an account corresponding to user A (corresponding to the “object set corresponding to the initiating party” according to the example embodiment illustrated by FIG. 1), and determining a number of red packets as “5,” an associated allocation constraint condition is further configured for the red packet. The allocation constraint condition includes a geographical location condition, such as “within a 200-meter range from the geographical location corresponding to the red packet,” the geographical location corresponding to the red packet being presumed to be a current geographical location of user A or an arbitrary geographical location specified by user A.

Step 208, the server sending a red packet notification to user B.

According to the present example embodiment, the server may determine alternative target parties satisfying the allocation constraint condition, and send a notification message relating to the red packet (corresponding to the object allocation set) to the alternative target parties. For example, since the above-mentioned red packet is initiated by user A in the conversation window corresponding to the belonged-to organization “Hard-Working Group,” the server may designate all members of the organization as alternative target parties of the red packet, and send the notification message relating to the red packet to each. For example, the above-described mentioned user B belongs to the organization, so the situation of the target party shall be described referring to user B by way of example.

Step 210, upon detecting user B triggering a red packet, collecting geographical location information of user B.

Step 212, the server receiving a red packet receiving request initiated by user B.

According to the present example embodiment, when the initiating party user A and the alternative target party user B belong to a same organization, as illustrated by FIG. 7, the red packet issued by user A may serve as content of the communication message, as shown in the message box of the conversation window. Then, upon detecting a trigger operation by user B towards the message box, this may be evaluated as detecting user B triggering the red packet.

Furthermore, in some cases, based on a trigger operation by user B towards the message box illustrated by FIG. 7, the red packet receiving page illustrated by FIG. 8 may be shown, and upon detecting user B clicking on the “Open red packet” text and icon on the red packet receiving page, this may be evaluated as user B completing a red packet trigger. Herein, according to the example embodiment illustrated by FIG. 8, the red packet receiving page is displayed floating above the conversation window, so that regardless of how many communication messages are received in the conversation window, or whether the communication message containing the red packet information has already been “swamped” by other communication messages, user B may still directly view the red packet receiving page, and perform trigger operations upon the red packet. Herein, on the red packet receiving page illustrated by FIG. 8, the type of the red packet is indicated through “Location red packet,” and the “Location red packet” may be further indicated as being based on a current geographical location of user A through “(Current location),” for evaluation of whether user B may receive the red packet.

According to the present example embodiment, with regard to the triggering of the red packet by user B, the electronic device of user B may collect a personal geographical location, and send the geographical location through a red packet receiving request to the server. Of course, if user B considers the personal geographical location sensitive, then, while viewing the “Location red packet” shown on the red packet receiving page illustrated by FIG. 8, user B may avoid clicking on the “Open red packet” text and icon, and, for example, click on the surrounding blank region, restore the conversation window illustrated by FIG. 7, and abandon receiving the red packet.

Step 214, the server evaluating whether user B is in accordance with a red packet issuance tendering condition.

Step 216, when the red packet tendering condition is satisfied, the server executing a red packet tendering operation.

According to the present example embodiment, when receiving a response message from an alternative target party regarding a notification message, if the alternative target party is determined as satisfying the allocation constraint condition, the alternative target party is designated as a target party, and an allocation operation is executed. For example, corresponding to the red packet configuration page illustrated by FIG. 4, the geographical location configured by user A is a current geographical location configured (or arbitrary geographical location), that is, the location will not change; then, the server will always directly compare the geographical location with the geographical location of user B, without the need to re-obtain the geographical location of user A.

According to the present example embodiment, a fashion of the server tendering red packets may employ any given fashion in the related technology, though of course the fashion may be adjusted by user A. In particular, the configured total amount in FIG. 4 is 10 yuan, and the number of red packets is five, so the total amount of 10 yuan may be allocated by averaging between five red packets, that is, the currency of each red packet is 2 yuan, and 2 yuan is allocated to, for example, user B. Alternatively, the total amount of 10 yuan may be allocated randomly between five red packets, so that currency of any random value among 0-10 yuan may be allocated to user B.

Step 218, the server informing user A and user B of the tendering results.

According to the present example embodiment, FIG. 9 illustrates a results page of red packet currency being successfully allocated to user B, where statuses of all tendering of red packet currency is may be seen, and user A may view tendering results on a similar tendering results page, which shall not be reiterated herein.

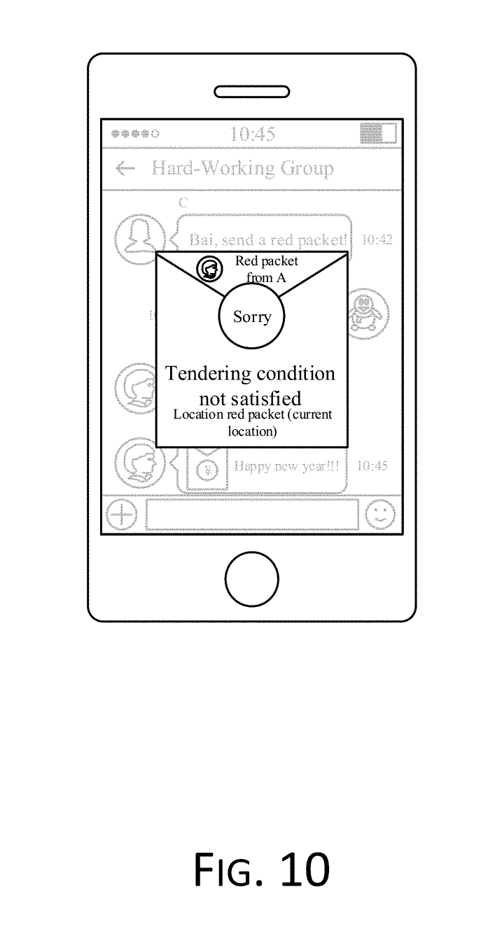

When user B does not satisfy an allocation constraint condition, upon the basis of the above-mentioned red packet receiving page illustrated by FIG. 8, “Tendering condition not satisfied” and such content illustrated by FIG. 10 may be shown, as a prompt to user B. Of course, since red packet currency is limited in number, if allocation is already complete for red packets when user B issues a red packet receiving request, so that user B, despite satisfying the allocation constraint condition, still cannot have red packet currency successfully allocated thereto, processing fashions in the related technology may be employed, which shall not be reiterated herein.

Based on a real-time geographical location of the initiating party, FIG. 11 is a flowchart of still another object allocation method provided by an exemplary embodiment of the present disclosure. As illustrated by FIG. 11, the method may include the following steps:

Step 1102, user A configuring a red packet.

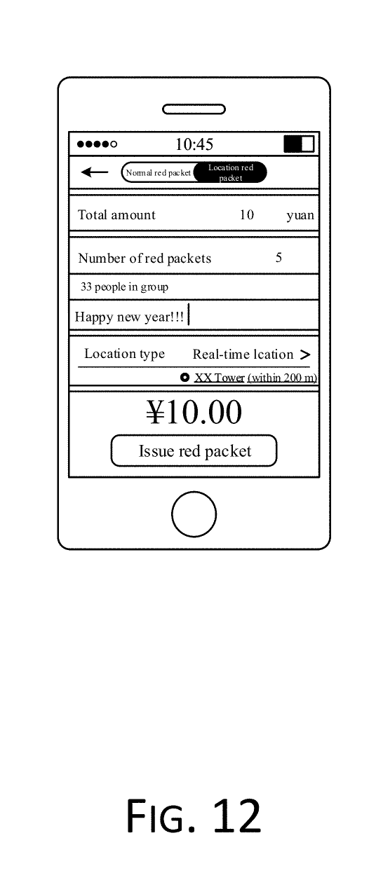

According to the present example embodiment, user A may, through the type adjusting page illustrated by FIG. 6, switch the “current position” illustrated by FIG. 4 to the “real-time location” illustrated by FIG. 12; herein, in order to distinguish the above-mentioned two location types, to the left of the words “XX Tower” in FIG. 12, a position marker different from that of FIG. 4 may be employed. With regard to other configuration procedures on the subject of red packets, reference may be made to step 202 illustrated by FIG. 2C, which shall not be reiterated herein.

Step 1104, the server receiving a red packet creating request initiated by user A.

According to the present example embodiment, since a “real-time location” is employed, that is, utilized to limit a geographical location of a geographical location condition to the real-time geographical location of user A, thus the red packet creating request need not contain a geographical location of user A, which needs to be independently obtained by the subsequent steps 1114-1116, which shall not be presaged herein.

Step 1106, the server generating a red packet.

Step 1108, the server sending a red packet notification to user B.

Step 1110, upon detecting user B triggering a red packet, collecting geographical location information of user B.

Step 1112, the server receiving a red packet receiving request initiated by user B.

According to the present example embodiment, steps 1106-1112 may refer to steps 206-212 illustrated by FIG. 2C, which shall not be reiterated herein.

Step 1114, the server initiating a location obtaining request to user A.

Step 1116, the server receiving a real-time geographical location returned from user A.

According to the present example embodiment, a geographical location condition is a preset range surrounding the real-time geographical location of user, effectively utilizing the a real-time geographical location of user A as a center, with a preset distance as a radius of a circular region, that is, an allocation-permitted region. Since, after user A creates a red packet, but before user B initiates a red packet receiving request, user A may exhibit an even greater range of movement, that is, the allocation-permitted region will change in real time with movements of user A. Thus, in order to ensure that only users truly situated within the allocation-permitted area may have red packets allocated thereto, after receiving the red packet receiving request, a location obtaining request needs to be initiated immediately (which may be understood as in real time) to user A, to obtain a real-time geographical location of user A.

Step 1118, the server evaluating whether user B is in accordance with a red packet tendering condition.

Step 1120, when the red packet tendering condition is satisfied, the server executing a red packet tendering operation.

Step 1122, the server informing user A and user B of the tendering results.

According to the present example embodiment, by substituting the geographical location corresponding to the red packet from the current location (or arbitrary location specified by user A) according to the example embodiment illustrated by FIG. 2C to the real-time geographical location of user A, steps 1118-1122 may refer to steps 214-218 of the example embodiment illustrated by FIG. 2C, which shall not be reiterated herein.

It should be noted that:

According to the example embodiment illustrated by the above-mentioned FIG. 2C and FIG. 11, when the red packet is initiated by user A in a “Hard-Working Group” conversation window, if only member users of the organization are designated as alternative target parties, the red packet is actually effectively configured with another allocation constraint condition: a user identity condition. In other words, the server may understand user A as having initiated the red packet creating request through a conversation window corresponding to the organization “Hard-Working Group,” and the server may determine an organization to which user A belongs as “Hard-Working Group,” and therefore only allow users such as user B belonging in common to the organization “Hard-Working Group” to initiate receiving requests directed at the red packet.

When the allocation constraint condition only contains a geographical location condition, the server may likewise determine alternative target parties satisfying the geographical location condition, and send a notification message relating to the red packet to the alternative target parties. Thus, even though user A initiates a red packet creating request in a conversation window corresponding to the belonged-to organization “Hard-Working Group,” as long as users are near (such as by 200 m) a geographical location configured by user A, whether or not belonging to the organization “Hard-Working Group,” the server may send notification messages relating to the red packet to each, granting each an opportunity to receive currency from the red packet.

According to this example embodiment, improved applications may be achieved in some settings through a geographical location condition being a sole limitation. For example, during promotional activities of physical merchants, a merchant may, based on a personal set geographical location, or a geographical location of the promotional activities, create a red packet, an allocation constraint condition of the red packet including only a geographical location condition, such as being within a 100-meter range from a store. Thus: when a user enters a 100-meter range from the store, the server may proactively push a notification message regarding a red packet created by the merchant to the user, so that the user, at the same time as receiving the red packet, may comprehend brand information, promotional information and the like of the merchant; moreover, since the store and the user are in close proximity, the user will have a greater probability of directly visiting the store.

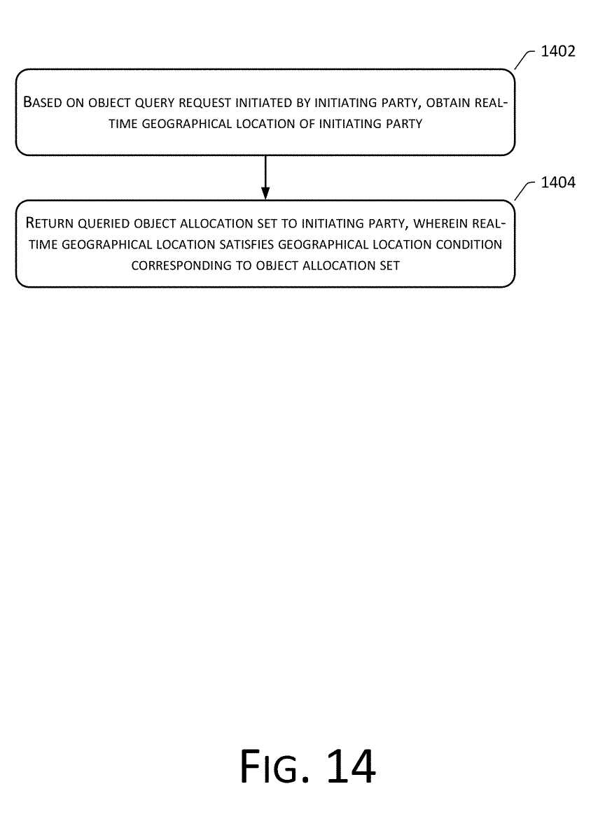

FIG. 14 is a flowchart of still another object allocation method provided by an exemplary embodiment of the present disclosure. As illustrated by FIG. 14, the method as applied to a server may include the following steps:

Step 1402, based on an object query request initiated by an initiating party, obtaining a real-time geographical location of the initiating party.

Step 1404, returning a queried object allocation set to the initiating party, wherein the real-time geographical location satisfies a geographical location condition corresponding to the object allocation set.

In contrast to, for example, step 208 according to the example embodiment illustrated by FIG. 2C and step 1108 according to the example embodiment illustrated by FIG. 11, the server according to the present example embodiment does not proactively push a notification message regarding an object allocation set to the user, in order to avoid too many or too frequent notification messages negatively impacting the user, but rather the user proactively queries, of the server, a nearby object allocation set. In one regard, this reflects that the user exhibits initiative towards the object allocation set, without risk of negatively impacting the user; in another regard, the user is detached from a sense of “receiving allocations,” and may proactively select object allocation sets of interest.

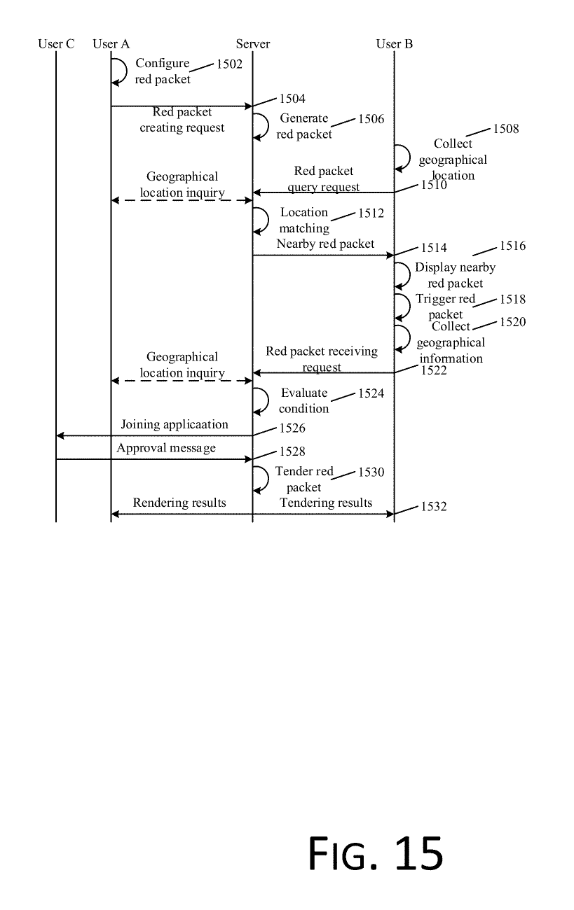

To facilitate understanding, the following combines exchange procedures between an initiating party, a target party and a server, in order to describe an object allocation scheme of the present disclosure. Herein, FIG. 15 is a flowchart of still another object allocation method provided by an exemplary embodiment of the present disclosure. As illustrated by FIG. 15, the method may include the following steps:

Step 1502, user A configuring a red packet.

Step 1504, the server receiving a red packet creating request initiated by user A.

Step 1506, the server generating a red packet.

According to the present example embodiment, steps 1502-1506 may refer to steps 202-206 illustrated by FIG. 2C, as well as refer to steps 1102-1106 illustrated by FIG. 11, which shall not be reiterated herein.

Of course, here the red packet creating procedure is only described referring to user A by way of example; in reality, other arbitrary users may create red packets for user B to query and receive, but the red packet creating procedure may still refer to the above-mentioned steps 1502-1506.

Step 1508, based on receiving a trigger operation by user B, collecting a geographical location of user B.

Step 1510, the server receiving a red packet query request sent by user B, the red packet query request containing the geographical location of user B.

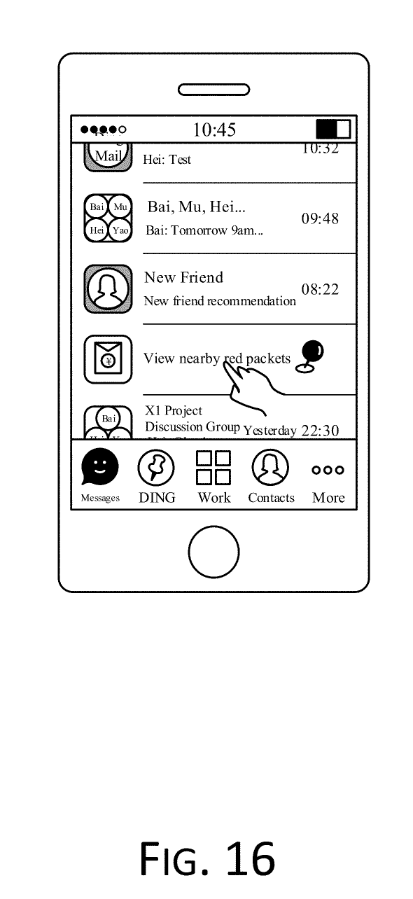

According to the present example embodiment, as illustrated by FIG. 16, user B may view the “View nearby red packets” function of an instant messaging application on an electronic device, and after user B triggers this function, the electronic device may collect a personal geographical location, and the geographical location is sent to the server through a red packet query request.

Step 1512, the server matches the geographical location of user B against geographical locations of created red packets.

Step 1514, the server obtains a red packet located near user B by matching, and informs user B of the matching results.

According to the present example embodiment, with user A as an example, when user A, through the example embodiment illustrated by FIG. 2C, causes a red packet to correspond to a personal, current geographical location or to a specified arbitrary geographical location, the server may directly match the current geographical location or the arbitrary geographical location with the geographical location of user B; when user A, through the example embodiment illustrated by FIG. 11, causes a red packet to correspond to a personal, real-time geographical location, the server, after step 1510, needs to initiate a geographical location inquiry to user A, and the obtained real-time geographical location is matched against the geographical location of user B.

Step 1516, the electronic device of user B performs information display for nearby red packets.

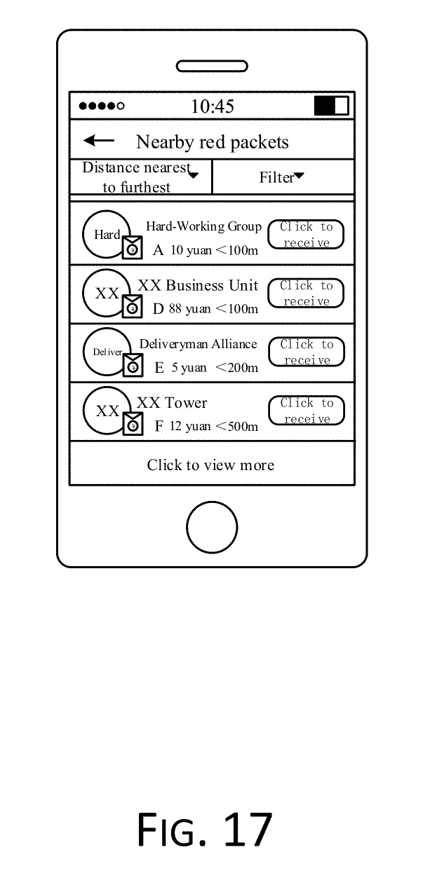

According to the present example embodiment, such as illustrated by FIG. 17, the electronic device of user B may display nearby red packets employing fashions such as a list. Herein, FIG. 17 displays multiple red packets employing a “distance from nearest to furthest” fashion, though of course, based on different viewing needs of user B, other fashions may be employed to perform sorting for display, such as “red packet currency from most to least” and the like. User B may, through triggering nearby the text “distance from nearest to furthest,” select a different sorting fashion. In addition, user B may further filter nearby red packets, such as “view only red packets within 100 meters,” filter by amount of currency of red packets, and the like.

Step 1518, detecting user B triggering a red packet.

Step 1520, collecting a geographical location of user B.

Step 1522, initiating a red packet receiving request to the server directed at the triggered red packet, the red packet receiving request containing the current geographical location of user B.

According to the present example embodiment, since movements over comparatively large distances may occur for user B, thereby in step 1520 the geographical location of user B may be re-collected. Of course, step 1520 is not essential, and the server may also directly utilized the geographical location of step 1508; for example, an effective duration may be set for the geographical location collected in step 1508, such as five minutes, such that the geographical location within the effective duration may be evaluated utilizing the condition of step 1524, and if the effective duration is exceeded, the geographical location needs to be re-collected through step 1520.

Step 1524, the server performing condition evaluation upon user B.

According to an example embodiment, an allocation constraint condition employed by the server may only include a geographical location condition, such that through matching the geographical location of user B against a geographical location of a source party of a selected red packet, if user B is within a present distance range of the source party (such as within 200 meters), whether user B satisfies the geographical location condition may be evaluated.

Suppose that user B selects a red packet issued by user A. Similar to the above step 1512, when user A, through the example embodiment illustrated by FIG. 2C, causes the red packet to correspond to a personal current geographical location or a specified arbitrary geographical location, the server may directly match the current geographical location or the arbitrary geographical location against the geographical location of user B; when user A, through the example embodiment illustrated by FIG. 11, causes the red packet to correspond to a personal real-time location, the server, after step 1522, needs to initiate a geographical location inquiry to user A, and the obtained real-time geographical location is matched against the geographical location of user B.

According to another example embodiment, an allocation constraint condition employed by the server may include a geographical location condition and a user identity condition. Herein, a geographical location condition may be: being within a preset distance range from a source party of the red packet. A user identity condition may be: belonging to a same organization as a source party of the red packet.

Then, in the case where an initiating party initiates an object obtaining request directed at any object allocation set, when the initiating party satisfies a geographical location condition of the any object allocation set, and the initiating party belongs to a same organization as an allocation source party of the any object allocation set, an allocation operation allocating the any object allocation set to the initiating party is executed. By way of example, suppose that user B selects a red packet issued by user A. In one regard, whether user B satisfies a geographical location condition corresponding to the red packet is evaluated, such as “is within 200 meters of user A”; in another regard, whether user B and user A belong to a same organization is evaluated, and particularly when user A initiates the red packet through organization “Hard-Working Group” (such as initiating a red packet through a conversation window corresponding to the organization “Hard-Working Group”), the organization may specifically refer to the organization “Hard-Working Group.” Therefore, the above-mentioned example embodiments may be suitable for, for instance, leisure activities of sending red packets among company colleagues, where, through geographical location conditions, colleagues not yet on duty, for example, are prevented from receiving red packets, and, through user identity conditions, other nearby individuals (such personnel of other companies in a same office building) are prevented from receiving red packets.

Step 1526, the server initiating a joining application directed at user C.

Step 1528, the server receiving an approval message returned from user C.

Step 1530, the server sends the red packet issued to user B.

Step 1532, the server sends tendering results relating to the red packet to user A and user B.

According to the present example embodiment, when the initiating party satisfies a geographical location condition corresponding to any object allocation set, and the initiating party does not belong to a same organization as the allocation source party of the any object allocation set, the server may send a joining application relating to the initiating party to an administrator of the organization to which the allocation source party belongs; wherein, after the joining application is approved, an allocation operation allocating the any object allocation set to the initiating party is executed.

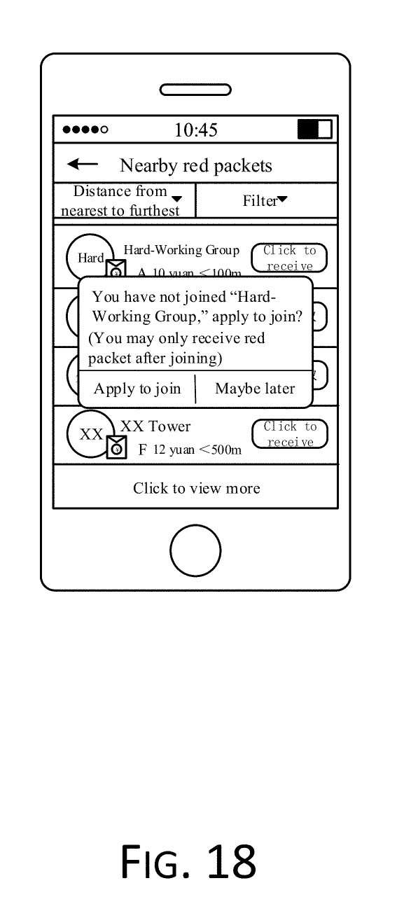

Still with the red packet tendered by user A through the organization “Hard-Working Group” as an example: when use B initiates a receiving request directed at the red packet towards the server, the server in one regard evaluates whether user B satisfies a geographical location condition corresponding to the red packet, such as “is within 200 meters of user A,” and in another regard evaluates whether user B and user A belong to a same organization, such as the organization “Hard-Working Group.” If User B only satisfies the geographical location condition, and does not satisfy the user identity condition, the server may send a joining application to an administrator of the organization “Hard-Working Group”; for example, the administrator may be user C. As illustrated by FIG. 18, the server may display a corresponding reminder page to user B, and only when user B selects “Apply to join” is a joining application sent to user B, and it is not sent otherwise.

In some scenarios, such when an operator of a physical store may create an organization relating to the physical store, and create a red packet, then a nearby user may, through the above-mentioned process, view the red packet; when the user clicks to receive the red packet, a joining application directed at the organization may be initiated towards an operator serving as an administrator (or a dedicated administrator), enabling the user to, at the same time as receiving red packet currency, be able to further view and comprehend the state of the physical store, helping to realize promotion of the physical store. Also, since the user has joined the organization corresponding to the physical store, the operator may then, through a fashion of subsequent message pushing, further promote information to the user.

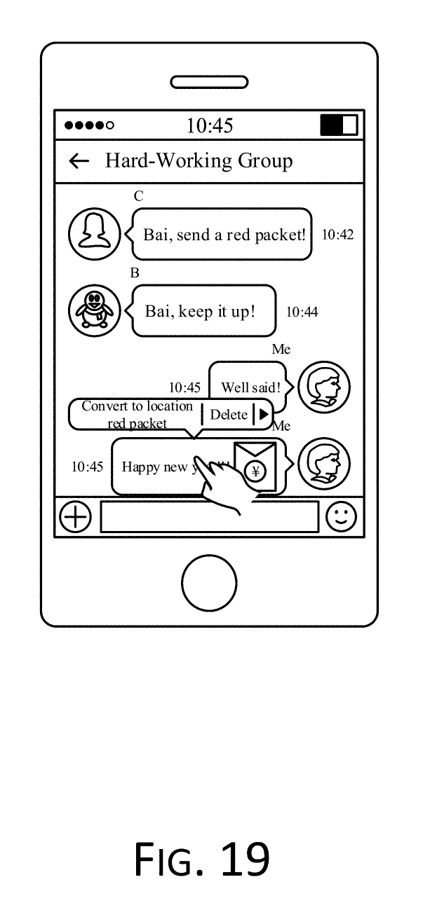

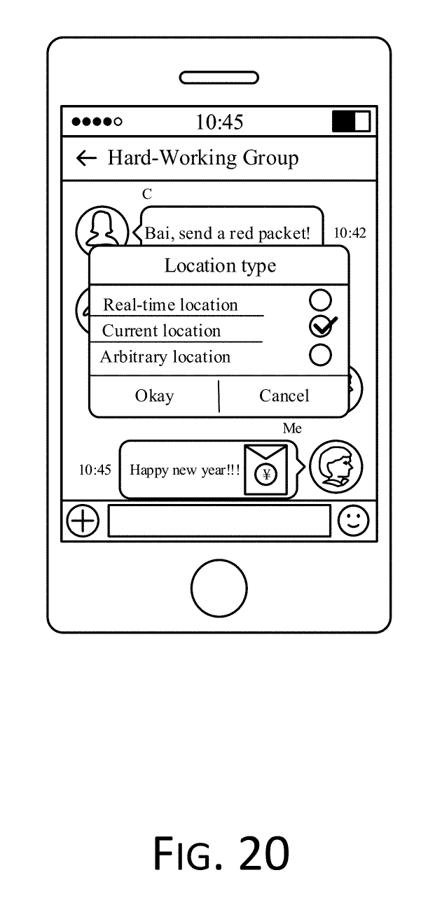

Additionally, aside from directly configuring red packet type as a “location red packet” through the red packet configuration page illustrated by FIG. 4 or FIG. 12, as illustrated by FIG. 19, a user may, after issuing a normal type of red packet, further trigger the red packet, and, through “Convert to location red packet” in a menu box corresponding to the trigger, convert the red packet to a “location red packet,” and through, for example, a window illustrated by FIG. 20, select a location type.

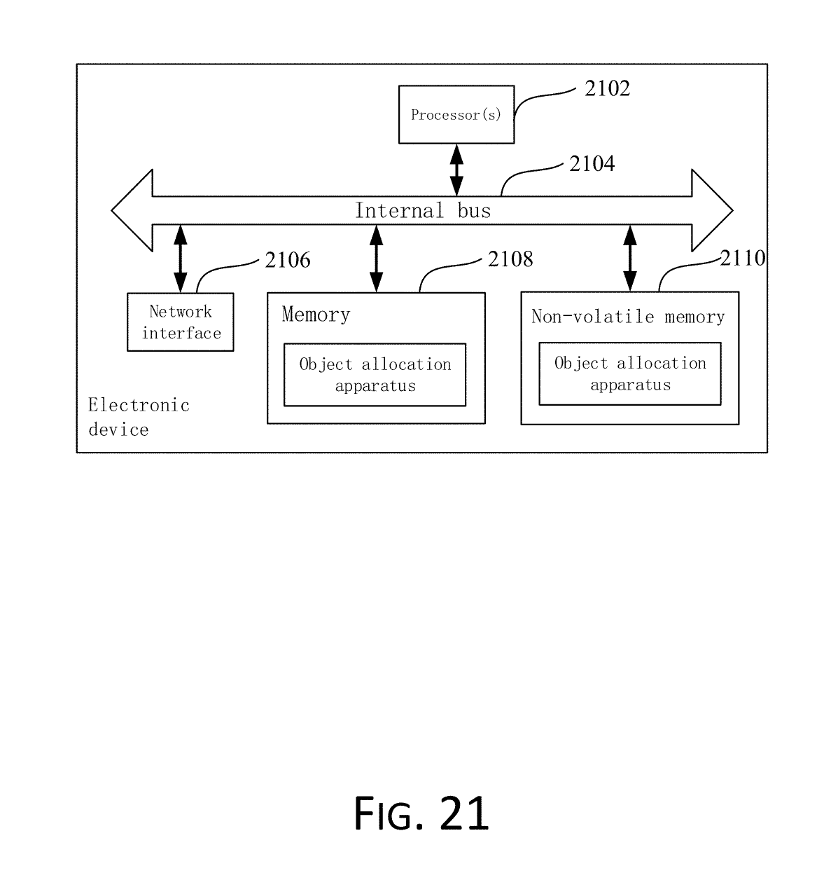

FIG. 21 is a schematic diagram of an electronic device provided by an exemplary application of the present disclosure. Referring to FIG. 21, at the hardware level, the electronic device includes a processor 2102, an internal bus 2104, a network interface 2106, memory 2108 and nonvolatile memory 2110, and may, of course, include other hardware as required for business purposes. The processor 2102 reads, from the nonvolatile memory 2110, a corresponding computer program into the memory 2102 and runs it, forming an object allocation apparatus at a logical level. Of course, the present disclosure does not exclude implementations such as logic devices, a combination of hardware and software, and the like, which is to say that the main execution body of the below processing flow is not limited to the respective logical units, but may also be hardware or logic devices.

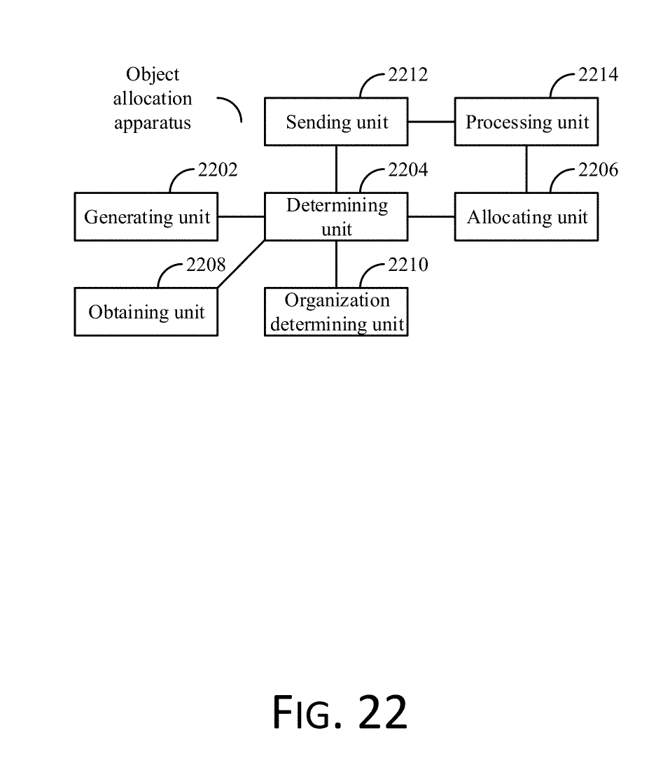

Referring to FIG. 22, the object allocation apparatus may include a generating unit 2202, a determining unit 2204 and an allocating unit 2206. Herein:

The generating unit 2202 is configured to, based on an object allocation request from an initiating party, generate an object allocation set; wherein, the object allocation set contains a specified number of objects extracted from an object set corresponding to the initiating party;

The determining unit 2204 is configured to determine an allocation constraint condition associated with the object allocation set, the allocation constraint condition including a geographical location condition;

The allocating unit 2206 is configured to allocate the object allocation set to a target party, wherein the target party satisfies the allocation constraint condition.

Optionally, further included is:

An obtaining unit 2208 configured to obtain a geographical location of the initiating party;

Wherein, the geographical location condition includes: being within a preset distance range from the geographical position.

Optionally, the geographical location includes one of the following:

A geographical location of the initiating party while initiating the object allocation request;

A geographical location of the initiating party while the target party initiates an object obtaining request; wherein, the object obtaining request is utilized to trigger the allocation operation;

An arbitrary geographical location specified by the initiating party.

Optionally, the allocation constraint condition further includes: a user identity condition.

Optionally, further included is:

An organization determining unit 2210 configured to determine an organization to which the initiating party belongs;

The user identity condition including: belonging to a same organization as the initiating party.

Optionally, further included is:

A sending unit 2212 configured to determine an alternative target party satisfying the allocation constraint condition, and send a notification message relating to the object allocation set to the alternative target party;

A processing unit 2214 configured to, when receiving a response message from the alternative target party regarding the notification message, if determining the alternative target party as satisfying the allocation constraint condition, designate the alternative target party as the target party, and executing the allocation operation.

Optionally, the object allocation request is initiated by the initiating party through a conversation window of an instant messaging application; wherein, the target party is an associated communicating party of the conversation window.

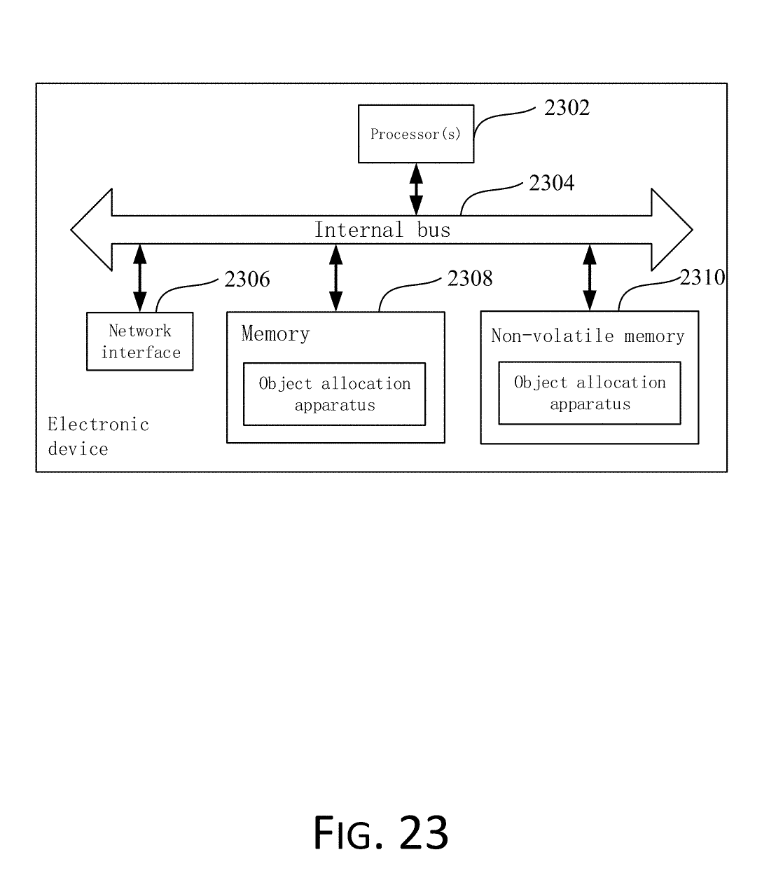

FIG. 23 is a schematic diagram of another electronic device provided by an exemplary embodiment of the present disclosure. Referring to FIG. 23, at the hardware level, the electronic device includes a processor 2302, an internal bus 2304, a network interface 2306, memory 2308 and nonvolatile memory 2310, and may, of course, include other hardware as required for business purposes. The processor 2302 reads, from the nonvolatile memory 2310, a corresponding computer program into the memory 2302 and runs it, forming an object allocation apparatus at a logical level. Of course, the present disclosure does not exclude implementations such as logic devices, a combination of hardware and software, and the like, which is to say that the main execution body of the below processing flow is not limited to the respective logical units, but may also be hardware or logic devices.

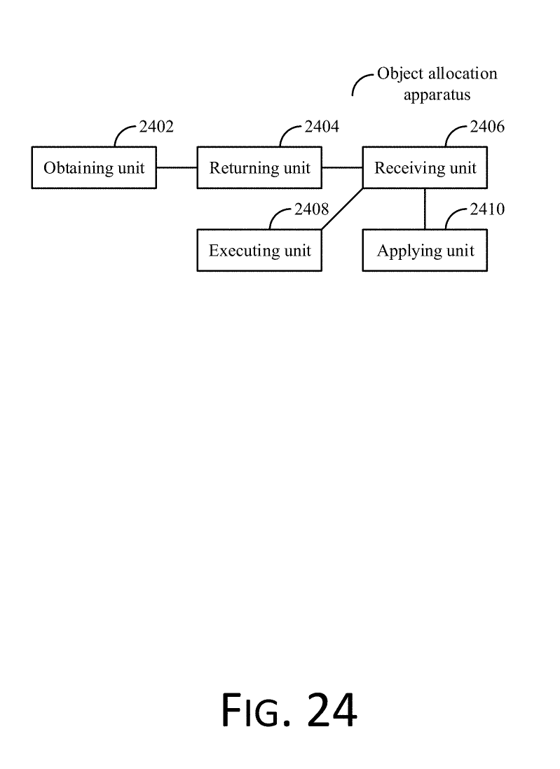

Referring to FIG. 24, the object allocation apparatus may include an obtaining unit 2402 and a returning unit 2404. Herein:

The obtaining unit 2402 is configured to, based on an object query request initiated by an initiating party, obtain a real-time geographical location of the initiating party;

The returning unit 2404 is configured to return a queried object allocation set to the initiating party, wherein the real-time geographical location satisfies a geographical location condition corresponding to the object allocation set.

Optionally, further included are:

A receiving unit 2406 configured to receive an object obtaining request initiated by the initiating party directed at any object allocation set;

An executing unit 2408 configured to, when the initiating party satisfies a geographical location condition of the any object allocation set, and the initiating party belongs to a same organization as an allocation source party of the any object allocation set, execute an allocation operation allocating the any object allocation set to the initiating party.

Optionally, further included is:

An applying unit 2410 configured to, when the initiating party satisfies a geographical location condition corresponding to any object allocation set, and the initiating party does not belong to a same organization as the allocation source party of the any object allocation set, send a joining application relating to the initiating party to an administrator of the organization to which the allocation source party belongs;

After the joining application is approved, the executing unit 2408 executes an allocation operation allocating the any object allocation set to the initiating party.

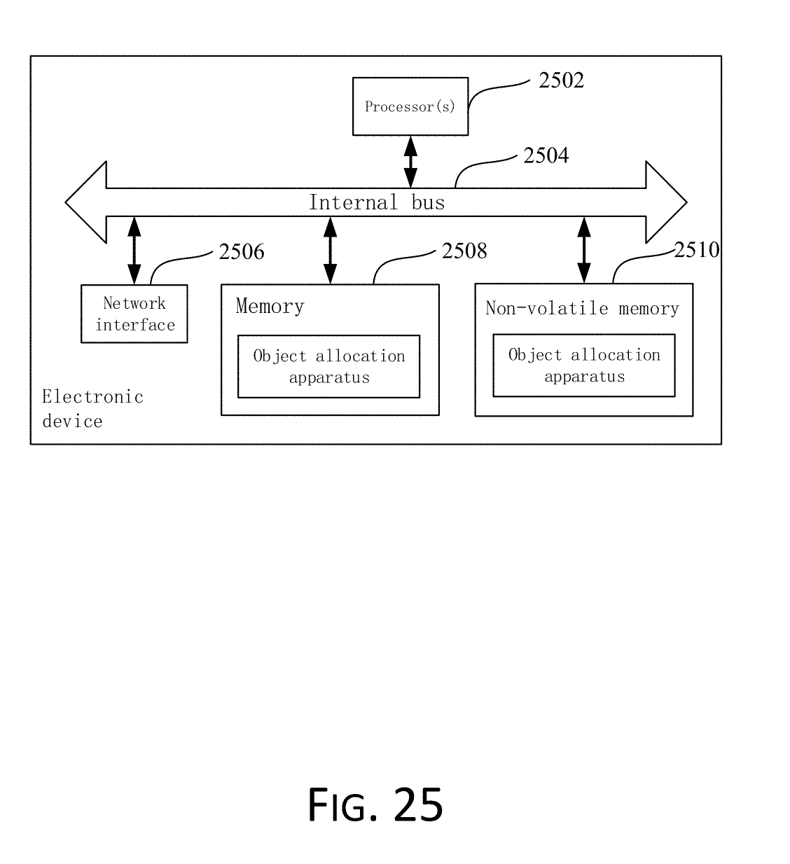

FIG. 25 is a schematic diagram of still another electronic device provided by an exemplary embodiment of the present disclosure. Referring to FIG. 25, at the hardware level, the electronic device includes a processor 2502, an internal bus 2504, a network interface 2506, memory 2508 and nonvolatile memory 2510, and may, of course, include other hardware as required for business purposes. The processor 2502 reads, from the nonvolatile memory 2510, a corresponding computer program into the memory 2502 and runs it, forming an object allocation apparatus at a logical level. Of course, the present disclosure does not exclude implementations such as logic devices, a combination of hardware and software, and the like, which is to say that the main execution body of the below processing flow is not limited to the respective logical units, but may also be hardware or logic devices.

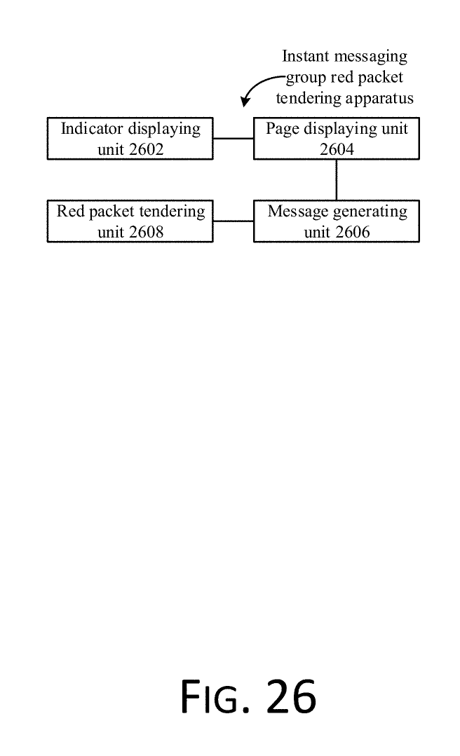

Referring to FIG. 26, the instant messaging group red packet tendering apparatus may include an indicator displaying unit 2602, a page displaying unit 2604, an information generating unit 2606 and a red packet tendering 2608. Herein:

The indicator displaying unit 2602 is configured to, in a conversation session window of an instant messaging group, show a red packet tendering gateway indicator;

The page displaying unit 2604 is configured to, based on receiving a user trigger command directed at the red packet tendering gateway indicator, show a red packet configuration page; wherein, the user trigger command is issued by a first group member of the instant messaging group;

The information generating unit 2606 is configured to, based on a user configuration command received by the red packet configuration page, generate red packet configuration information; wherein, the red packet configuration information includes a first geographical location determined by the first group member;

A red packet tendering unit 2608 is configured to initiate to the server a red packet tendering request containing the red packet information, causing the server to create a red packet associated with the first geographical location, and the server to send an instant messaging message regarding the red packet to at least one second group member(s) of the instant messaging group, further causing the at least one second group member(s) to, through a trigger towards the instant messaging group, and in the case when second geographical location(s) of the at least one second group member(s) satisfy a preset relationship with the first geographical location, receive at least part of the red packet.

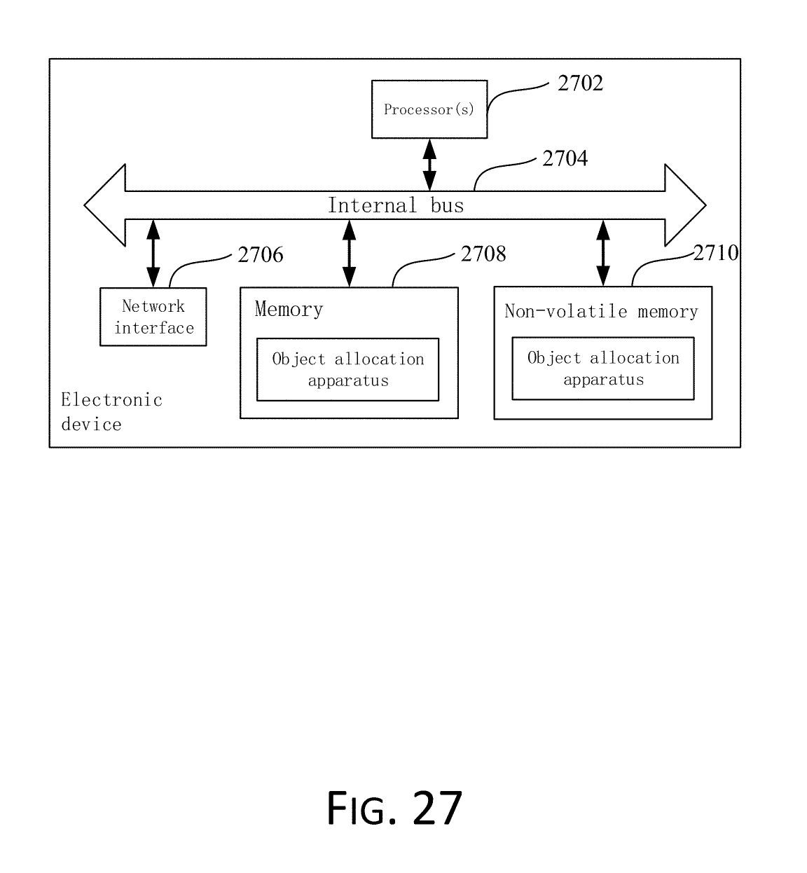

FIG. 27 is a schematic view of still another electronic device provided by an exemplary embodiment of the present disclosure. Referring to FIG. 27, at the hardware level, the electronic device includes a processor 2702, an internal bus 2704, a network interface 2706, memory 2708 and nonvolatile memory 2710, and may, of course, include other hardware as required for business purposes. The processor 2702 reads, from the nonvolatile memory 2710, a corresponding computer program into the memory 2702 and runs it, forming an object allocation apparatus at a logical level. Of course, the present disclosure does not exclude implementations such as logic devices, a combination of hardware and software, and the like, which is to say that the main execution body of the below processing flow is not limited to the respective logical units, but may also be hardware or logic devices.

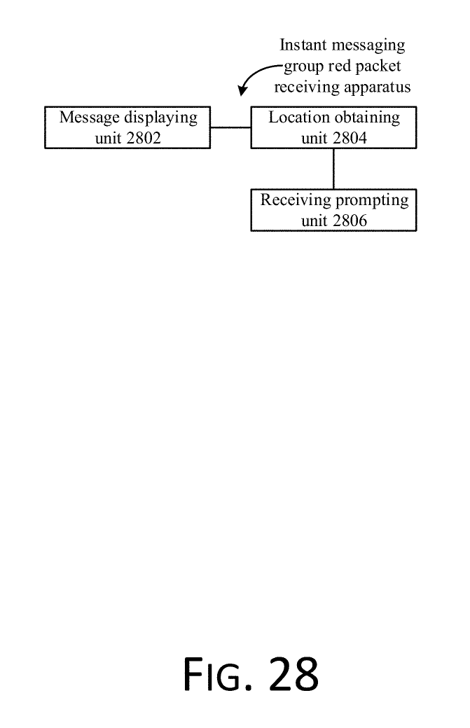

Referring to FIG. 28, the instant messaging group red packet receiving apparatus may include a message displaying unit 2802, a position obtaining unit 2804 and a receiving prompting unit 2806. Herein:

The message displaying unit 2802 is configured to, in a conversation window of an instant messaging group, show an instant messaging message from a first group member, the instant message corresponding to a red packet tendered by the first group member;

The position obtaining unit 2804 is configured to, when the red packet is associated with a first geographical location of the first group member, based on receiving a red packet receiving command from a second group member directed at the instant messaging message, obtain a second geographical location of the second group member;

The receiving prompting unit 2806 is configured to, in the case where the second geographical location satisfies a preset relationship with the first geographical location, show on a prompt page that at least part of the red packet is successfully received by the second group member.

According to a typical configuration, a computing device includes one or more processors (CPU), input/output interfaces, network interfaces, and memory.

The memory may include a form of computer-readable media such as a volatile memory, a random access memory (RAM) and/or a nonvolatile memory, for example, a read only memory (ROM) or a flash RAM. The memory is an example of computer-readable memory medium.

The computer-readable media include a volatile or non-volatile type, a removable or non-removable media, which may achieve storage of information using any method or technology. The information may include a computer-readable instruction, a data structure, a program module or other data. Examples of computer-storage media include, but are not limited to, phase-change memory (PRAM), static random access memory (SRAM), dynamic random access memory (DRAM), other types of random-access memory (RAM), read-only memory (ROM), electrically erasable programmable read only memory (EEPROM), quick flash memory or other memory technology, compact disc read-only memory (CD-ROM), digital versatile disc (DVD) or other optical storage, magnetic cassette tape, magnetic disk storage or other magnetic storage devices, or any other non-transmission medium, which may be used to store information that may be accessed by computing device. As defined herein, the computer-readable media does not include transitory media, such as modulated data signals and carrier waves.

It should be further noted that the terms “include,” “containing,” “comprising,” or any other variation thereof, are intended to cover non-exclusive inclusion, so that a process, method, article, or device including a series of elements does not only include those elements, but further include other elements not expressly listed, or further includes inherent elements of such processes, methods, articles, or devices. Where no additional limitation is made, an element defined by the wording “including a . . . ” does not exclude other same elements being present in a process, method, article, or device including the element.

Herein, exemplary embodiments are described in detail and expressed by illustration in the drawings. Where the above description refers to the drawings, unless otherwise indicated, the same numbers in different drawings indicate the same or similar elements. Manners of implementation described in the above exemplary embodiments do not represent all manners of implementation consistent with the present disclosure. To the contrary, they are merely examples of apparatuses and methods consistent with some aspects of the invention, as recited by the attached claims.

Terminology employed by the present disclosure is merely for the purpose of describing particular example embodiments, and is not intended to limit the present disclosure. The singular forms “a,” “an,” and “the” employed in the present disclosure and the attached claims are also intended to include plural forms unless the overall context clearly indicates other meaning. It should also be understood that the term “and/or” employed in this text refers to and includes any or all possible combinations of one or more of the associated listed subject matter.

It should be understood that, although the present disclosure may employ the language “first,” “second,” “third” and the like to describe a variety of information, this information should not be limited by this language. This language is merely used to distinguish information of a same type from one another. For example, without departing from the scope of the present disclosure, “first information” may also be designated as “second information,” and, similarly, “second information” may also be designated as “first information.” Depending on the context, as used herein, the word “if” may be interpreted as “when . . . ” or “upon . . . ” or “in response to determining.”

The foregoing is merely preferred embodiments of the present disclosure, not intended to limit the present disclosure, and any modifications, equivalent substitutes, improvements, and the like, made within the spirit and principles of the disclosure shall be included within the scope of protection of the present disclosure.

1. A method comprising:
based on an object allocation request from an initiating party, generating an object allocation set, wherein the object allocation set contains a specified number of objects extracted from among an object set corresponding to the initiating party;
determining an allocation constraint condition associated with the object allocation set, the allocation constraint condition including a geographical location condition; and
allocating the object allocation set to a target party, wherein the target party satisfies the allocation constraint condition.

2. The method of claim 1, further comprising:
obtaining a geographical location of the initiating party;
wherein the geographical location condition comprises being within a preset distance range from the geographical position.

3. The method of claim 2, wherein the geographical location comprises one of:
a geographical location of the initiating party while initiating the object allocation request;
a geographical location of the initiating party while the target party initiates an object obtaining request, wherein the object obtaining request is utilized to trigger the allocation operation; and
an arbitrary geographical location specified by the initiating party.

4. The method of claim 1, wherein the allocation constraint condition further comprises a user identity condition.

5. The method of claim 4, further comprising:
determining an organization to which the initiating party belongs;
wherein the user identity condition comprises belonging to a same organization as the initiating party.

6. The method of claim 1, further comprising:
determining an alternative target party satisfying the allocation constraint condition, and sending a notification message relating to the object allocation set to the alternative target party; and
upon receiving a response message from the alternative target party determined as satisfying the allocation constraint condition regarding a notification message, designating the alternative target party as a target party, and executing an allocation operation.

7. The method of claim 1, wherein the object allocation request is initiated by the initiating party through a conversation window of an instant messaging application;
and wherein the target party is an associated communicating party of the conversation window.

8. A method comprising:
obtaining a real-time geographical location of an initiating party based on an object query request initiated by the initiating party; and
returning a queried object allocation set to the initiating party, wherein the real-time geographical location satisfies a geographical location condition corresponding to the object allocation set.

9. The method of claim 8, further comprising:
receiving an object obtaining request initiated by the initiating party directed at any object allocation set; and
executing an allocation operation allocating the any object allocation set to the initiating party, the initiating party satisfying a geographical location condition of the any object allocation set and belonging to a same organization as an allocation source party of the any object allocation set.

10. The method of claim 9, further comprising:
sending a joining application relating to the initiating party to an administrator of the organization to which the allocation source party belongs, the initiating party satisfying a geographical location condition corresponding to any object allocation set and not belonging to a same organization as the allocation source party of the any object allocation set; and
executing an allocation operation allocating the any object allocation set to the initiating party after the joining application is approved.

11.-12. (canceled)

13. An apparatus comprising:
one or more processors;
memory;
a generating unit stored in the memory and configured to be executable by the one or more processors, based on an object allocation request from an initiating party, generate an object allocation set, wherein the object allocation set contains a specified number of objects extracted from among an object set corresponding to the initiating party;
a determining unit stored in the memory and configured to be executable by the one or more processors to determine an allocation constraint condition associated with the object allocation set, the allocation constraint condition including a geographical location condition; and
an allocating unit stored in the memory and configured to be executable by the one or more processors to allocate the object allocation set to a target party, wherein the target party satisfies the allocation constraint condition.

14. The apparatus of claim 13, further comprising:
an obtaining unit stored in the memory and configured to be executable by the one or more processors to obtain a geographical location of the initiating party;
wherein the geographical location condition includes: being within a preset distance range from the geographical position.

15. The apparatus of claim 14, wherein the geographical location comprises one of:
a geographical location of the initiating party while initiating the object allocation request;
a geographical location of the initiating party while the target party initiates an object obtaining request, wherein the object obtaining request is utilized to trigger the allocation operation; and
an arbitrary geographical location specified by the initiating party.

16. The apparatus of claim 13, wherein the allocation constraint condition further comprises a user identity condition.

17. The apparatus of claim 16, further comprising:
an organization determining unit stored in the memory and configured to be executable by the one or more processors to determine an organization to which the initiating party belongs;
wherein the user identity condition comprises: belonging to a same organization as the initiating party.

18. The apparatus of claim 13, further comprising:
a sending unit stored in the memory and configured to be executable by the one or more processors to determine an alternative target party satisfying the allocation constraint condition, and send a notification message relating to the object allocation set to the alternative target party; and
a processing unit stored in the memory and configured to be executable by the one or more processors to, upon receiving a response message from the alternative target party regarding the notification message and determining the alternative target party as satisfying the allocation constraint condition, designate the alternative target party as the target party, and executing the allocation operation.

19. The apparatus of claim 13, wherein the object allocation request is initiated by the initiating party through a conversation window of an instant messaging application, and wherein the target party is an associated communicating party of the conversation window.

20.-24. (canceled)

25. The method of claim 2, further comprising obtaining the geographical location of the initiating party a second time after the geographical location of the initiating party has changed.

26. The method of claim 2, wherein the geographical location of the initiating party is not obtained a second time.

27. The method of claim 2, wherein the geographical location of the initiating party is either obtained a second time or not obtained a second time, based on configuration of the object allocation set.
